(19) United States
(12) Patent Application Publication
(10) Pub. No.: US 2021/0293588 A1
(43) Pub. Date: Sep. 23, 2021

(54) METHOD FOR COMPENSATING FOR AN ERROR FUNCTION OF A FIELD DEVICE IN AN AUTOMATION TECHNOLOGY SYSTEM

(71) Applicant: Endress+Hauser SE+Co. KG, Maulburg (DE)

(72) Inventors: Eric Birgel, Schopfheim (DE); Markus Kilian, Merzhausen (DE); Ralf Schmidt, Kembs (FR); Reinhard Buchner, Nesselwang (DE)

(21) Appl. No.: 17/259,624

(22) PCT Filed: Jun. 13, 2019
(86) PCT No.: PCT/EP2019/065443

§ 371 Date: Jan. 12, 2021

(30) Foreign Application Priority Data
Jul. 12, 2018 (DE) 10 2018 116 893.4

(51) Int. Cl. G01D 21/00; G05B 19/05

(52) U.S. Cl. CPC G01D 21/00; G05B 2219/25011; G05B 19/05

(57) ABSTRACT

A method for compensating for an error function is disclosed, wherein a field device has a sensor unit. The method includes transferring properties of the sensor unit to the field device. The properties contain information regarding process variables collected by the sensor unit. The method includes transferring the device status of the field device or the sensor unit to a plurality of field devices, and establishing a substitution system, wherein the properties of the sensor unit and the device status are known to the plurality of field devices, and the field devices independently determine which process variable of a sensor unit can substitute a process variable of another sensor unit with a predetermined degree of accuracy. The method also includes transferring the substitute variable to the higher-level unit in the event that at least one predetermined device status of a field device or a sensor unit arises.

The invention relates to a method for compensating for an error function of a field device in an automation technology system, wherein a plurality of field devices is provided in the system, wherein each of the field devices has at least one sensor unit which is designed for collecting at least one process variable, wherein the field devices are integrated in a first communication network and communicate with a higher-level unit and with one another, and wherein the field devices transfer the collected process values, diagnostic data, and status information to the higher-level unit via the communication network.

Field devices that are used in industrial automation technology systems are already known from the prior art. Field devices are often used in process automation, as well as in manufacturing automation. Field devices, in general, refer to all devices which are process-oriented and which supply or process process-relevant information. Field devices are thus used for detecting and/or influencing process variables. Sensor units are used for detecting process variables. They are used, for example, for pressure and temperature measurement, conductivity measurement, flow measurement, pH measurement, fill-level measurement, etc., and detect the corresponding process variables of pressure, temperature, conductivity, pH value, fill-level, flow, etc. Actuator systems are used for influencing process variables. These are, for example, pumps or valves that can influence the flow of a fluid in a pipe or the fill-level in a tank. In addition to the aforementioned measuring devices and actuators, field devices are also understood to include remote I/O's, radio adapters, or, generally, devices that are arranged at the field level.

In modern industrial systems, field devices are usually connected to higher-level units via communication networks, such as fieldbuses (Profibus®, Foundation® Fieldbus, HART®, etc.). The higher-level units are control units, such as a SPS (programmable logic controller). The higher-level units are used for, among other things, process control, as well as for the commissioning of the field devices. The measured values detected by the field devices, in particular by the sensor units, are transferred via the respective bus system to a (or possibly several) higher-level unit(s) that further process the measured values, as appropriate, and forward them to the control station of the system. The control station serves for process visualization, process monitoring, and process control via the higher-level units. In addition, a data transfer is also required from the higher-level unit via the bus system to the field devices, in particular for configuration and parameterization of field devices, as well as for the control of actuators.

In the course of progressive digitization in terms of the catchphrases “Internet of things (IoT)” and “Industry 4.0,” which also does not stop at the components of process systems, there is an increased need to make data from field devices, in particular measurement data, diagnostic data, parameter values, etc., available at a central location and to create added value from these data (catchphrases here are “big data analysis,” “predictive maintenance,” etc.). The central location is frequently understood to be a database that can be contacted via the Internet, in particular a so-called cloud-enabled database.

Nowadays, however, sensor systems are mainly controlled by a higher-level unit via the industrial fieldbus networks listed above, and their data are transferred to the higher-level unit. In this case, the intelligence is located centrally on the part of the higher-level unit. The current transformation caused by advancing digitization has resulted in intelligence increasingly being relocated decentrally to the individual field devices. In the future, the individual sensor systems will increasingly be able to obtain information on their own initiative.

The failure of a field device sometimes means high cost and time investments. Particularly in critical processes, the relevant system part has to be shut down until the field device has been repaired or replaced. As an alternative thereto, redundancies are often installed in advance into the relevant system part. As a rule, these are field devices which are identical to the field devices used and which replace a relevant field device in the event of a fault.

In light of this problem, the invention is based on the object of providing a method which allows the maintenance of an automation technology system to be simplified.

The object is accomplished by a method for compensating for an error function of a field device in an automation technology system, wherein a plurality of field devices is provided in the system, wherein each of the field devices has at least one sensor unit which is designed for collecting at least one process variable, wherein the field devices are integrated in a first communication network and communicate with a higher-level unit and with one another, and wherein the field devices transfer the collected process values, diagnostic data, and status information to the higher-level unit via the communication network, comprising:
transferring properties of the sensor unit of a field device to each of the other field devices, wherein the properties contain information relating to which type of process variables can be collected by the sensor unit;
transferring the device status of the field devices and/or of the sensor units to each of the other field devices, in particular continually or at defined points in time;
establishing a substitution system, wherein the properties of each of the sensor units and the device status of each of the field devices and/or of each of the sensor units are known to each of the field devices, and wherein in the course of establishing the substitution system, the field devices independently determine which process variable of a sensor unit can substitute a process variable of another sensor unit as a substitute variable with a predetermined degree of accuracy; and
transferring the substitute variable to the higher-level unit in the event that at least one predetermined device status of a field device or of a sensor unit arises.

The great advantage of the method according to the invention is that the failures of a field device or of its sensor unit can be remedied easily. Instead of providing a redundant replacement device, the field devices independently determine a substitute variable. The substitute variable is transferred to the higher-level unit until a user ends the transfer. The failed field device can be repaired or replaced in the meantime without the affected system part having to be shut down and the process having to be interrupted.

The desired degree of accuracy of the substitute variable compared to the failed process variable can be defined by the user in advance. As a result, field devices or sensor systems whose detected process variables deviate too much from the failed field device are not considered.

In this way, a temperature sensor, for example, can replace a failed temperature sensor. The field devices have knowledge of the type of process values detected by all field devices, or by their sensor units, and of their typical variables.

Examples of device statuses which trigger the transfer of the substitute variable are, for example, “Maintenance required” and/or “Device offline.”

Examples of field devices and their sensor units that are mentioned in connection with the method according to the invention are already described as examples in the introductory part of the description.

According to an advantageous development of the method according to the invention, further properties of a field device, or of a sensor system of the field device, are transferred to the plurality of field devices and compared in the course of establishing the substitution system. The accuracy of the substitute variable is increased as a result because not only are the pure process measured values of the actual process variable compared to potential process variables, but further metadata are also included.

In a preferred embodiment of the method according to the invention, it is provided that the further properties contain information regarding the geographical position of the field device.

In an advantageous embodiment of the method according to the invention, it is provided that the further properties include information regarding the measuring point at which the field device is installed and/or the function of the field device at the measuring point.

According to a preferred embodiment of the method according to the invention, it is provided that the substitute variable is only transferred to the higher-level unit if the substitute variable is confirmed by a predetermined number of field devices. Such a majority system improves reliability and compensates for any miscalculation of one of the field devices.

According to an advantageous development of the method according to the invention, it is provided that the history of the substitute variable is compared to historical data of the determined process variable of the field device at which the at least one predetermined device status has occurred, and is confirmed only if the values of the substitute variable is plausible in relation to the historical data. For example, the course of the process variables over time is compared. If the substitute variable shows a different course than the original process variable (for example, original process variable: level of the process values increasing over time; substitute variable: level of the process values falling over time), the substitute variable is not plausible and is therefore not suitable for adequately replacing the failed field device or its sensor unit.

In an advantageous embodiment of the method according to the invention, it is provided that in the course of establishing the substitution system, the field devices determine whether sensor units collect process variables that are redundant with respect to one another. “Redundant” in this context means that the process variables are almost identical. Furthermore, it is the same type of device as well as the same function of a field device or of its sensor unit. The latter is also located at the same measuring point.

According to an advantageous development of the method according to the invention, it is provided that in the event of a predetermined device status of one of the field devices, or of one of the sensor systems, which collects a redundant process variable, no substitute variable is transferred to the higher-level unit. Since a redundant process variable is present, no substitute variable has to be provided since this redundant process variable already replaces the failed process variable.

An advantageous embodiment of the method according to the invention provides that a wired communication network, in particular an Ethernet-based communication network, is used as the first communication network. It can also be a fieldbus of automation technology, e.g., based on one of the protocols HART, Profibus PA/DP, Foundation Fieldbus, etc. It can also be provided that the first communication network consists of a plurality of subsegments which may potentially be based on different protocols.

An alternative advantageous embodiment of the method according to the invention provides that a wireless communication network is used as the first communication network. The wireless communication network is in particular based on the WLAN or WiFi standard. Alternatively, any other conventional wireless standard may be used.

In a first variant of the method according to the invention, it is provided that the field devices communicate with one another and with the higher-level unit via the first communication network.

In a second variant of the method according to the invention, it is provided that the field devices communicate with the higher-level unit via the first communication network and that the field devices communicate with one another via a second communication network, in particular via a wireless communication network. In this way, additional data traffic on the first communication network is prevented and its performance is not restricted.

The invention is explained in greater detail with reference to the following figures. These show:

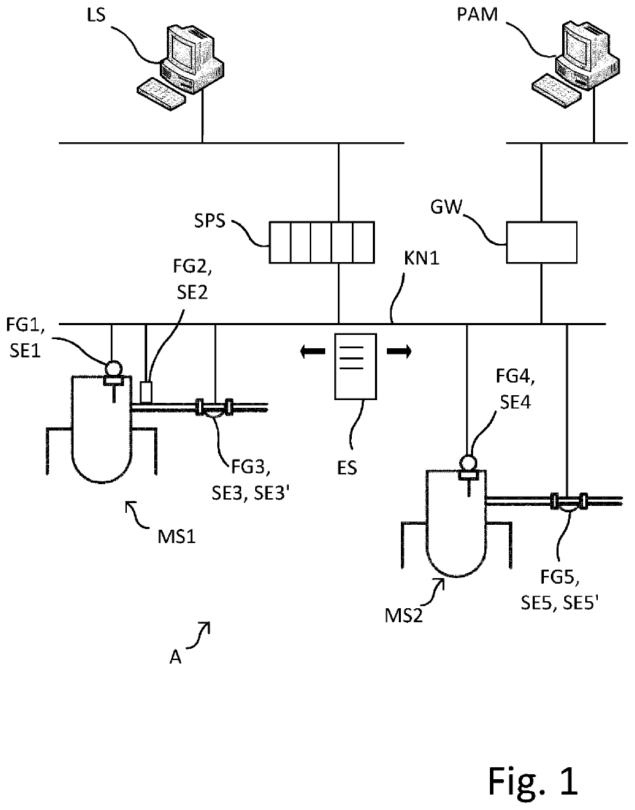

FIG. 1: a first exemplary embodiment of the method according to the invention;

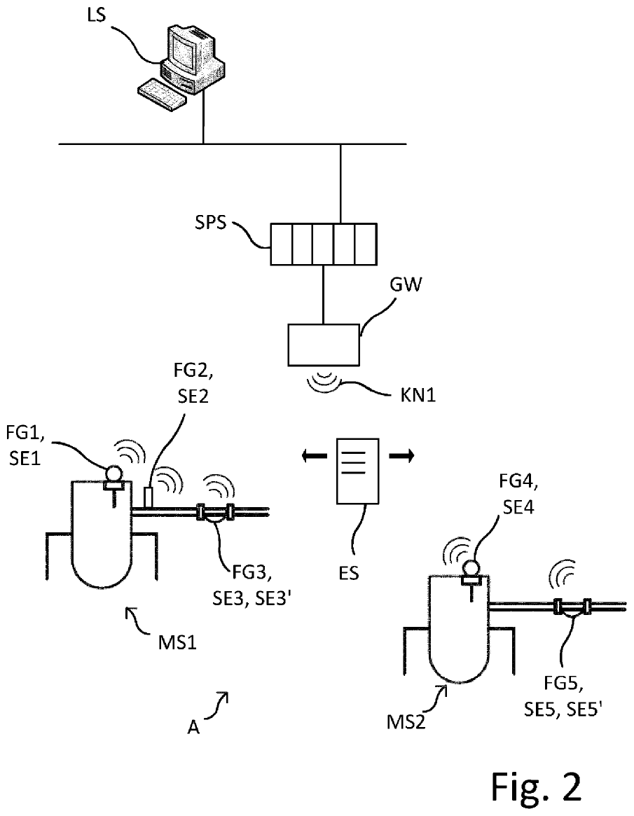

FIG. 2: a second exemplary embodiment of the method according to the invention; and

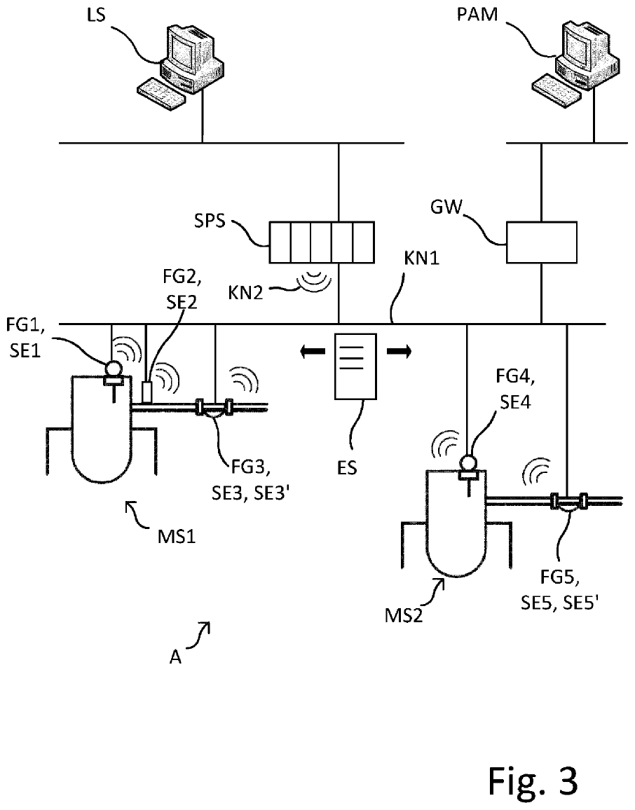

FIG. 3: a third exemplary embodiment of the method according to the invention.

FIG. 1 shows parts of an automation technology system A. Specifically, it shows two measuring points MS1, MS2. These respectively consist of a tank and a pipeline which discharges from the tank. In order to measure the fill-level of the tank as a process variable, a field device FG1, FG4, e.g., a fill-level meter by means of a radar as sensor unit SE1, SE4, is respectively attached to the tank. In order to measure the flow rate in the pipeline, a field device FG3, FG5 the sensor unit SE3, SE5 of which determines the flow rate of a medium flowing through the pipeline as the primary process variable according to the Coriolis principle is respectively attached. Each of the field devices FG3, FG5 furthermore has a temperature sensor SE3′, SE5′ as a further sensor unit, which detects the temperature of the medium flowing through the pipeline as a secondary process variable. Furthermore, another field device FG2 is attached at the measuring point MS1, which device determines the temperature of the measured medium flowing through the pipeline by means of a high-precision temperature sensor SE2 as a sensor unit.

The field devices F1, . . . , F5 are interconnected by means of a first communication network KN1 and are in communication with one another. The first communication network KN1 is, in particular, an Ethernet network. Alternatively, the first communication network KN1 is a fieldbus according to one of the known fieldbus standards, e.g., Profibus, Foundation Fieldbus, or HART.

The first communication network KN1 includes a higher-level unit SPS, e.g., a programmable logic controller, which transfers commands to the field devices FG1, FG5, whereupon the field devices FG1, . . . , FG5 transfer process values, diagnostic data, and status information to the higher-level unit SPS. These process values, diagnostic data, and status information are forwarded by the higher-level unit SPS to a workstation PC in the control center LS of the system A. This serves inter alia for process visualization, process monitoring and for engineering, such as for operating and monitoring the field devices FG1, . . . , FG5.

Furthermore, the first communication network KN1 includes a gateway GW which listens in on the process values, diagnostic data, and status information transferred by the field devices FG1, . . . , FG5 to the higher-level unit SPS and provides them to an external communication network, e.g., an IT network of the system operator or to the Internet. The data are transferred, for example, to a plant asset management system PAM, which is located in the IT network or can be reached as a cloud-enabled application on a server through the Internet. Such a plant asset management system PAM is used to manage the assets, i.e., inventories, of the system A.

The following describes an application of the method according to the invention: In order to be able to react to a failure of a field device FG1, . . . , FG5 or of a sensor unit SE1, . . . , SE5′ of one of the field devices FG1, . . . , FG5 without the process of the system A or of the measuring points MS1, MS2 having to be interrupted, the field devices FG1, . . . , FG5 independently generate a substitution system. The latter includes all the sensor units SE1, . . . , SE5′ of the field devices FG1, . . . , FG5, their collected process variables, and for each of the sensor units SE1, . . . , SE5′, a list of the sensor units SE1, . . . , SE5′ that can replace one of the sensor units SE1, . . . , SE5′ as substitute variable in the event of a failure. Furthermore, a degree of accuracy with which a substitute variable matches the process variable to be replaced is calculated for each of the substitute variables.

In order to create the substitution system ES, the field devices FG1, . . . , FG5 communicate with one another via the first communication network KN1. In this case, the field devices FG1, . . . , FG5 exchange information about the type of process variables which can be detected by their sensor units SE1, . . . , SE5′, information about the geographical position of the field devices FG1, . . . , FG5, information about the measuring points MS1, MS2 at which the field devices FG1, . . . , FG5 are installed, information about the function of the field devices FG1, . . . , FG5 at the measuring points MS1, MS2, the process variables collected by the sensor units SE1, . . . , SE5′, and historical data of the process variables collected by the sensor units SE1, . . . , SE5′, etc. Furthermore, the field devices FG1, . . . , FG5 transfer their current device status or the device status of their sensor units SE1, . . . , SE5′.

In the example shown in FIG. 1, the temperature sensor SE2 of the field device FG2 fails some time after the substitution system ES is created. The field device changes to the “maintenance required” device status and no longer detects new temperature values. The new device status is received by the remaining field devices FG1, FG3, FG4, FG5. Each of the field devices subsequently applies the substitution system, determines substitute variables for the failed process variable, and compares the degree of accuracy of each of the potential substitute variables to one another.

In the present example, two potential substitute variables are determined: the collected temperature value of the temperature sensor SE3′ of the field device FG3 and the collected temperature value of the temperature sensor SE5′ of the field device FG5. The degrees of accuracy of the two potential substitute variables are then compared to one another. The potential substitute variable of the field device FG5 provides a low, insufficient degree of accuracy in this case. The field device FG5 is located at a measuring point MS2 that differs from the measuring point MS1 so that the historical data of the field devices FG2 and FG5 also deviate greatly from one another.

The potential substitute variable of the field device FG3 shows high degree of accuracy. The field device FG3 is located at the same measuring point MS1 at which the field device FG2 is located. Apart from a slight offset, the historical data of the field devices FG2 and FG3 are the same so that the substitute variable indicates the temperature of the measured medium in the pipeline sufficiently well.

The substitute variable of the sensor unit SE3′ of the field device FG3 is therefore proposed by each of the field devices FG1, FG3, FG4, FG5. It may be provided that, in the case of different proposals, a simple majority must be required in order to determine a substitute variable. The determined substitute variable is subsequently transferred to the higher-level unit SPS. Said unit transfers the current values of the substitute variable continuously to the control center LS of the system with the note “substitute variable SE2” where they can be used and evaluated until the field device FG2 is serviced.

The great advantage of the method according to the invention is that the process does not have to be shut down and can be continued without problems. Depending on the criticality of the process, however, the required degree of accuracy of the substitute variable must be set correspondingly high in order to be able to ensure a safe further operation of the process. The substitute variable is determined with the calculation of all field devices FG1, FG3, FG4, FG5, which reduces errors (swarm intelligence).

FIGS. 2 and 3 show further exemplary embodiments. The method sequence is identical in this case, but the network structure is changed.

In FIG. 2, the first communication network KN1 is of wireless design. The WiFi protocol is used here. However, any other suitable wireless protocol can also be used, e.g., WirelessHART, etc. The wireless signal is received by a gateway GW, which forwards the signals to the control unit. The network architecture shown in FIG. 2 is shown by way of example. Any other suitable network architecture may be used. For example, it can be provided that the control unit itself has a radio module.

FIG. 3 uses the same network architecture of the first communication network as shown in FIG. 1. In addition, the field devices FG1, . . . , FG5 and the higher-level unit SPS use a second wireless communication network KN2. The field devices FG1, . . . , FG5 and the higher-level unit SPS are designed to exchange process values, diagnostic data, and status information via the first communication network KN1. All data that have to be exchanged in the course of establishing the substitution system ES and determining the substitute variable are exchanged via the wireless second communication network KN2. In this way, additional data traffic on the first communication network KN1 is prevented and its performance is not restricted.

### LIST OF REFERENCE SIGNS

A Automation technology system

ES Substitution system

FG2, FG3, FG4, FG5 Field device

GW Higher-level unit, gateway

KN1 First communication network

KN2 Second communication network

MS1, MS2 Measuring point

PAM Plant asset management system

SE1, SE2, SE3, SE3′, SE4, SE5, SE5′ Sensor unit

SPS Higher-level unit, control unit

1-12. (canceled)

13. A method for compensating for an error function of a field device in an automation technology system, wherein a plurality of field devices is provided in the system, wherein each of the field devices has at least one sensor unit which is designed for collecting at least one process variable, wherein the field devices are integrated in a first communication network and communicate with a higher-level unit and with one another, and wherein the field devices transfer the collected process values, diagnostic data, and status information to the higher-level unit via the communication network, comprising:
transferring properties of the sensor unit of a field device to each of the other field devices, wherein the properties contain information relating to which type of process variables can be collected by the sensor unit;
transferring the device status of the field devices or of the sensor units to each of the other field devices;
establishing a substitution system, wherein the properties of each of the sensor units and the device status of each of the field devices or of each of the sensor units are known to each of the field devices, and wherein in the course of establishing the substitution system, the field devices independently determine which process variable of a sensor unit can substitute a process variable of another sensor unit as a substitute variable with a predetermined degree of accuracy; and
transferring the substitute variable to the higher-level unit in the event that at least one predetermined device status of a field device or of a sensor unit arises.

14. The method of claim 13, wherein in the course of establishing the substitution system, further properties of a field device or of a sensor system of the field device are transferred to the plurality of field devices and compared.

15. The method of claim 14, wherein the further properties include information regarding the geographical position of the field device.

16. The method of claim 14, wherein the further properties contain information regarding the measuring point at which the field device is installed or the function of the field device at the measuring point.

17. The method of claim 13, wherein the substitute variable is only transferred to the higher-level unit if the substitute variable is confirmed by a predetermined number of field devices.

18. The method of claim 13, the history of the substitute variable is compared to historical data of the determined process variable of the field device at which the at least one predetermined device status has occurred, and is confirmed only if the values of the substitute variable is plausible in relation to the historical data.

19. The method of claim 13, wherein in the course of establishing the substitution system, the field devices determine whether the sensor units collect process variables that are redundant with respect to one another.

20. The method of claim 19, wherein the case of a predetermined device status of one of the field devices, or of one of the sensor systems, which collects a redundant process variable, no substitute variable is transferred to the higher-level unit.

21. The method of claim 13, wherein a wired communication network, in particular an Ethernet-based communication network, is used as the first communication network.

22. The method of claim 13, wherein a wireless communication network is used as the first communication network.

23. The method of claim 13, wherein the field devices communicate with one another and with the higher-level unit via the first communication network.

24. The method of claim 13, wherein the field devices communicate with the higher-level unit via the first communication network, and wherein the field devices communicate with one another via a second communication network via a wireless communication network.
